(19) United States
(12) Patent Application Publication
(10) Pub. No.: US 2008/0313856 A1
(43) Pub. Date: Dec. 25, 2008

(54) Hinge guard

(76) Inventors: Doyle H. Thompson, Arvada, CO (US); Jean M. Thompson, Arvada, CO (US)

Correspondence Address: DOYLE THOMPSON, 8296 WEST 71st PLACE, ARVADA, CO, 80004, US

(21) Appl. No.: 11/820,202

(22) Filed: Jun. 19, 2007

(51) Int. Cl. E05D 11/00

(52) U.S. Cl. 16/251

(57) ABSTRACT

The invention is related to an overhead paneled garage door. This flexible cover will mount over the hinges, using the existing screws or bolts. This will protect vehicles, individuals or other objects from damage or injuries when the door is opened or closed.

### FIELD OF INVENTION

This invention is directed to overhead garage door hinges.

### BACKGROUND OF THE INVENTION

There has been no suggestion of prior art to this invention.

### BRIEF SUMMARY OF THE INVENTION

This invention relates to a protective cover for overhead door hinges, to protect vehicles or other objects, or individuals from injury when the door is opened or closed. The material will flex as the door sections move up and down.

### BRIEF DESCRIPTION OF THE DRAWING

FIG. 1. Is the top view of the body of the invention.

FIG. 2. Is the side view of the invention.

FIG. 4. Is the holes in the flexible material to secure the cover over the door hinge.

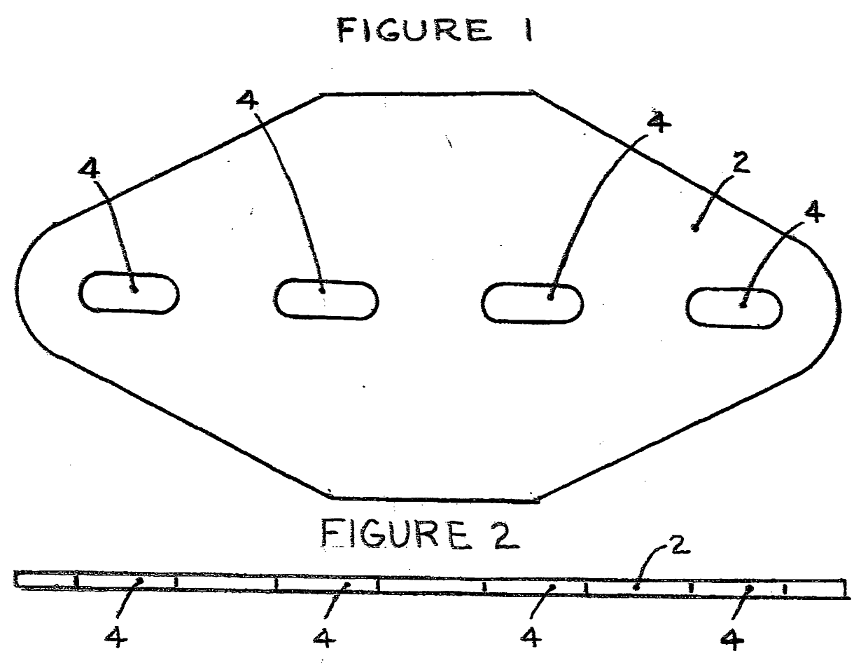

These, and other objects of the invention, will be apparent from the following, more particular, description of the preferred embodiment, as illustrated in the accompanying drawing in which reference characters refer to the same part.

Throughout the various views, the drawing is not necessarily to scale. Emphasis instead being placed upon illustrating the principles of the invention.

### DETAILED DESCRIPTION

Hinge Cover Body 2 having openings 4 allowing screws to secure hinge cover 2 to a garage door panel.

What is claimed is:

1. A hinge cover comprising:
Protection of garage door hinges. This cover protects sharp edges of panel hinges from damaging vehicles, personal property and injury to individuals.

2. The hinge cover further comprising slots or openings to allow cover to be attached to hinge using existing hinge bolts or screws.
